(19) United States
(12) Patent Application Publication
(10) Pub. No.: US 2006/0236664 A1
(43) Pub. Date: Oct. 26, 2006

(54) Filter system

(75) Inventors: Ulrich Stahl, Laudenbach (DE); Uwe Felber, Abtsteinach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/411,509

(22) Filed: Apr. 26, 2006

(30) Foreign Application Priority Data
Apr. 26, 2005 (DE) DE10 2005 019 262

(51) Int. Cl. B01D 47/00

(52) U.S. Cl. 55/413

(57) ABSTRACT

A filter system including a first filter designed as a folded filter having fold peaks and fold valleys, having an air intake side and an air outlet side, and a second filter, which is situated on the air intake side of the first filter, the first filter and the second filter being bonded together using at least one weld.

This application claims the benefit of German Patent Application No. 10 2005 019 262.9 filed Apr. 26, 2005 and hereby incorporated by reference herein.

The present invention provides a filter system, including a first filter, designed as a folded filter having fold peaks and fold valleys, having an air intake side and an air outlet side, and a second filter situated on the air intake side of the first filter, as well as a method for its manufacture and its use.

### BACKGROUND

Filter systems of this type are known from EP 0 411 240 A1. The filter system is suitable in particular as an engine air intake filter for filtering dusty engine intake air, as occurs in construction site operation, for example. The previously known filter system has a first filter, designed as a folded main filter, and a second filter, made of a nonwoven of a greater thickness, designed as a prefilter. The previously known filter system is designed as a tubular filter cartridge, the prefilter and the main filter being fixed in their position using support rings on the internal circumference and the external circumference.

### BRIEF SUMMARY OF THE INVENTION

The present invention is based on an object of refining the filter system in such a way that the number of parts is reduced.

The present invention provides the first filter and the second filter are bonded together using at least one weld. Because of the weld, the first filter and the second filter are materially joined together and fixing the two components through further elements may be dispensed with. In particular, fixing the two filters by support rings may be dispensed with. Since separate fixing of the first and second filters is not necessary, extrusion coating the filter edges using a plastic for fixing may be dispensed with, for example. Welds may be produced cost-effectively and, in addition, in contrast to adhesive bonds, are resistant to moisture penetrating into the filter system. The filter system thus may be suitable in particular for use in the area of construction sites for filtering dusty and damp engine intake air.

The first filter may be made of a nonwoven. The first filter may have a large filter area because of the folded structure. Large quantities of air may thus be passed through the first filter against low flow resistance.

The second filter may be made of a nonwoven. Due to the open structure, a second filter, made of a nonwoven, binds coarse dust particles and penetrating moisture in particular. The nonwoven is preferably a thermoplastic nonwoven and may be made of polyester, for example. In a further embodiment, the second filter may be made of a foam. Foams may be cost-effective to manufacture and have a high separation efficiency of coarse particles and a long time of operation if designed appropriately.

The first filter may be designed as a main filter and the second filter may be designed as a prefilter. Due to the division into prefilter and main filter, a filter system having a long service life and a low flow resistance at the same time may result. The main filter may have a high initial separation efficiency due to its denser structure. The main filter may reach the maximum separation performance after a certain time of operation, since particles accumulate in the filter material during operation. Primarily coarse particles may be retained in the prefilter, which occur in particular in dusty areas such as construction sites. A filter system having a high separation efficiency over a long time of operation thus may result.

The fold peaks or the fold valleys may be designed as rounded. The insertion of the welding tools into the filter may be simplified by the rounded form.

The second filter may contact the first filter by pressing against the first filter at least partially along the fold peaks or the fold valleys of the first filter, and the first filter may be at least partially welded to the second filter at the contact points. The filter system may be dimensionally very stable and resistant to bending due to the multiple welded contact points distributed over the filter area.

The weld maybe applied as a straight line along the fold peaks or the fold valleys. The linear welds may additionally increase the stability of the filter system.

The weld may be applied by spot welding. Welds of this type are my be produced rapidly and cost-effectively.

The present invention also provides a method for manufacturing a filter system, a first filter designed as a folded filter being provided, a second filter being provided, the second filter being situated on the air intake side of the first filter and the first filter and the second filter being at least partially welded. The filter system may be insensitive to moisture due to the weld and components for fixing the two filters may be dispensed with due to the material bond between the first and second filters. Welds may be produced easily and cost-effectively. The welding method may be integrated easily into the manufacturing process. Already manufactured folded filters made of a nonwoven and filter mats made of a nonwoven may be used as semifinished products, since the two components are bonded only after they are manufactured.

The first filter and the second filter may be welded together using ultrasonic welding. In ultrasonic welding, the two filters are pressed together at a pressure of 2 N/mm² to 5 N/mm² using a comb-like plunger on one side and a counterplunger on the other side. One or both stamps are set into ultrasonic vibrations using a generator. These ultrasonic vibrations cause relative movements of the contacting filter areas of first and second filters. The frictional heat resulting from this relative movement causes local melting of the fibers of the nonwoven of the prefilter, the molten fibers bonding irreversibly. After cooling, the first filter is permanently bonded to the second filter. Ultrasonic welding thus may be suitable in particular for materially joining nonwovens.

A further object of the present invention provides the use of the filter system as an engine air intake filter of a motor vehicle. Due to the bonding of first and second filters using a weld, the filter system may be insensitive to moisture. Since the filter system is additionally capable of filtering dusty air, the filter may be suitable in particular as an engine air intake filter of a construction site vehicle. The filter system according to the present invention additionally may have few parts.

### BRIEF DESCRIPTION OF THE DRAWINGS

Some exemplary embodiments of the filter system according to the present invention are explained in greater detail in the following on the basis of FIGS. 1 through 4:

FIG. 1 shows a filter system according to the present invention;

FIG. 2 shows the filter system in a top view having linear welds;

FIG. 3 shows the filter system in a top view having punctual welds;

FIG. 4 shows a cartridge-shaped filter system; and

FIG. 5 shows a filter system having rounded fold peaks.

### DETAILED DESCRIPTION OF THE EMBODIMENTS

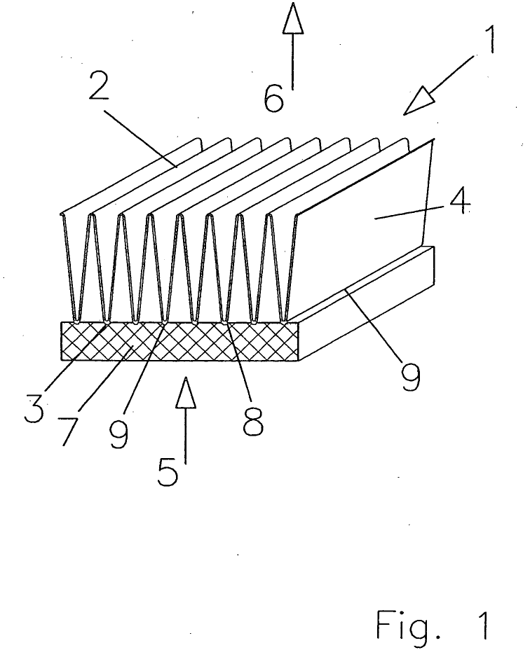

FIG. 1 shows a filter system 1, which is assembled from a first filter 4 and a second filter 7. In this embodiment, filter system 1 is designed in the form of a cuboid cassette filter. First filter 4 is made of a nonwoven and is designed as a folded filter having fold peaks 2 and fold valleys 3 and has an air intake side 5 and an air outlet side 6. First filter 4 forms the main filter of filter system 1. Second filter 7, which forms the prefilter, is situated on air intake side 5 of first filter 4. Second filter 7 may be made of polyester, for example. In other embodiments, other thermoplastic materials may also be used; for example, second filter 7 may be made of a foam. Second filter 7 contacts first filter 4 by pressing second filter 7 against fold peaks 2 of first filter 4. First filter 4 and second filter 7 are welded together using a weld 8 on these areas, contact points 9. Filter system 1 is designed in particular as an engine air intake filter of a motor vehicle, in particular a construction site vehicle here.

To manufacture the filter system, first filter 4 and second filter 7 are provided. Second filter 7 is situated on air intake side 5 of first filter 4 and both filters 4, 7 are welded together at contact points 9 using ultrasonic welding. Weld 8 may be improved by a surface activated by prior plasma activation.

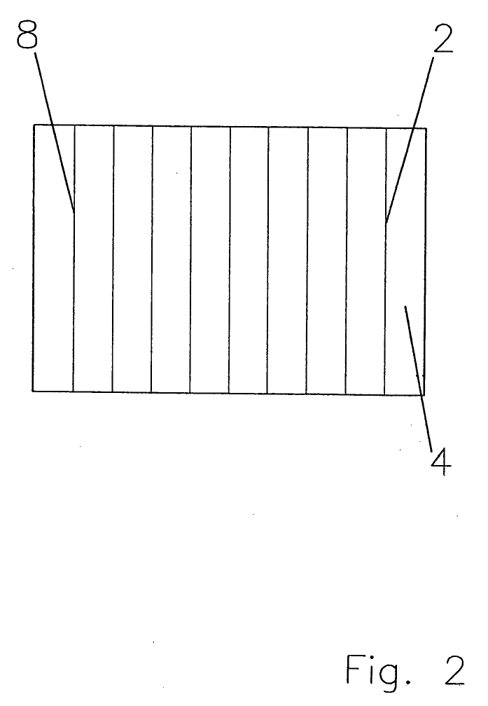

FIG. 2 shows a top view of filter system 1 according to FIG. 1. Welds 8 are applied as straight lines along fold peaks 2 in this embodiment.

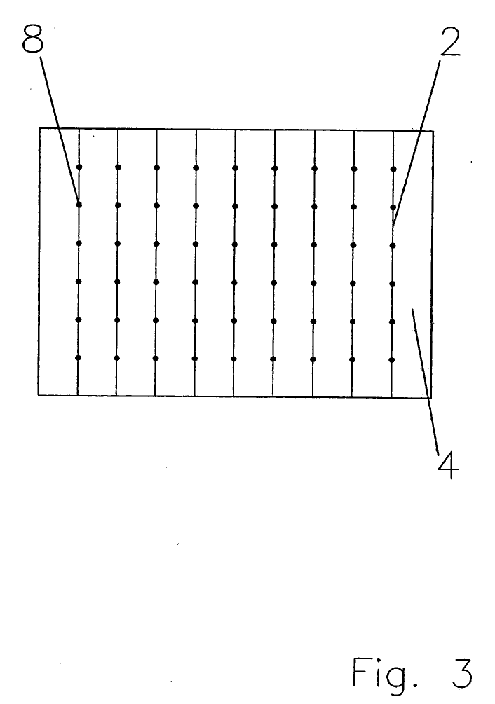

FIG. 3 shows a top view of filter system 1 according to FIG. 1. Welds 8 are applied by spot welding along fold peaks 2 in this embodiment.

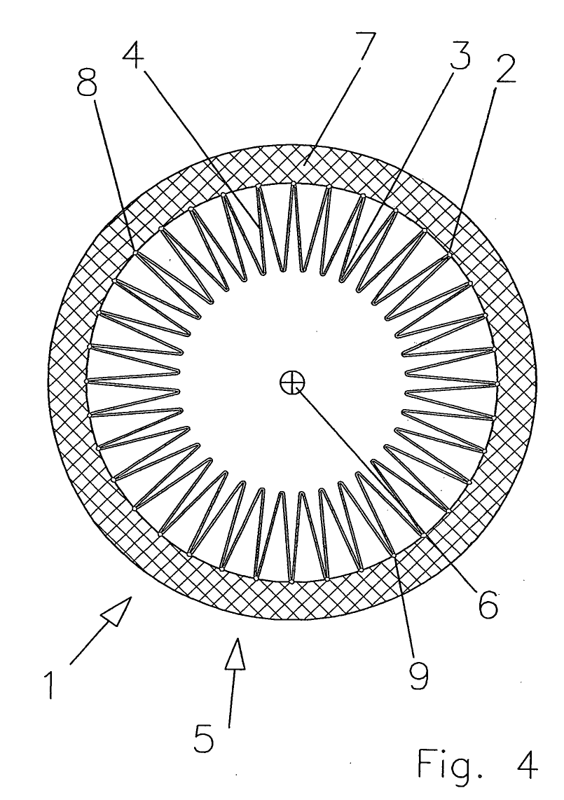

FIG. 4 shows filter system 1 according to FIG. 1, filter system 1 being designed as a cylindrical filter cartridge in this embodiment. Air intake side 5 is located on the outer circumference and outlet side 6 is located on the inner circumference of filter system 1. Second filter 7 is situated concentrically on the outer circumference of first filter 4. Filter system 1 is designed in particular as an engine air intake filter of a motor vehicle, in particular of a construction site vehicle here.

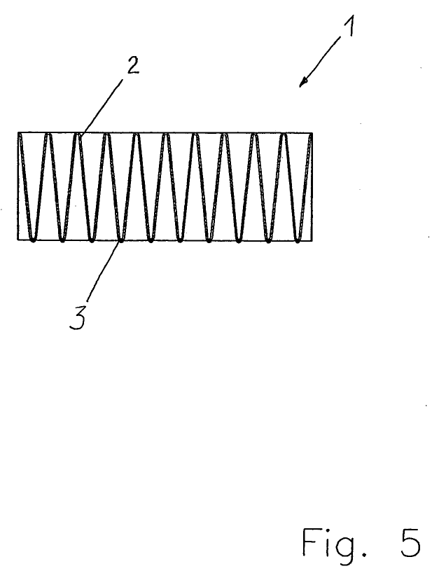

FIG. 5 shows a filter system 1 according to FIG. 1, fold peaks 2 and fold valleys 3 being designed as rounded.

What is claimed is:

1. A filter system comprising:
a first filter having an air intake side and an air outlet side and being folded so as to have fold peaks and fold valleys; and
a second filter situated on the air intake side of the first filter; and
the first filter and the second filter bonded together via at least one weld.

2. The filter system as recited in claim 1 wherein the first filter is a nonwoven.

3. The filter system as recited in claim 1 wherein the second filter is a nonwoven.

4. The filter system as recited in claim 1 wherein the second filter is a foam.

5. The filter system as recited in claim 1 wherein the first filter is a main filter and the second filter is a prefilter.

6. The filter system as recited in claim 1 wherein the fold peaks or the fold valleys are rounded.

7. The filter system as recited in claim 1 wherein the second filter contacts the first filter at least partially by pressing against the fold peaks or the fold valleys of the first filter and the first filter is at least partially welded to the second filter at contact points.

8. The filter system as recited in claim 7 wherein the weld is applied as straight lines along the fold peaks or the fold valleys.

9. The filter system as recited in claim 7 wherein the weld is applied by spot welding.

10. An engine air intake filter of a motor vehicle comprising the filter system as recited in claim 1.

11. A method for manufacturing a filter system comprising the steps of:
providing a first filter designed as a folded filter;
providing a second filter;
situating the second filter on the air intake side of the first filter; and
welding, at least partially, the first filter and the second filter.

12. The method as recited in claim 11 wherein welding includes ultrasonic welding.
